(19) United States
(12) Patent Application Publication
(10) Pub. No.: US 2014/0361501 A1
(43) Pub. Date: Dec. 11, 2014

(54) CARRIER

(71) Applicant: CAL-COMP ELECTRONICS & COMMUNICATIONS COMPANY LIMITED, New Taipei City (TW)

(72) Inventors: Buo-Hong Lin, New Taipei City (TW); Hung-Huan Sung, New Taipei City (TW); Chi-Hung Chang, New Taipei City (TW)

(73) Assignee: CAL-COMP ELECTRONICS & COMMUNICATIONS COMPANY LIMITED, New Taipei City (TW)

(21) Appl. No.: 13/964,126

(22) Filed: Aug. 12, 2013

(30) Foreign Application Priority Data
Jun. 5, 2013 (TW) 102119977

(51) Int. Cl. B62D 7/22

(52) U.S. Cl. CPC B62D 7/22
USPC 280/5.506

(57) ABSTRACT

A carrier including a body and a gravity modulating module disposed at the body is provided. The gravity modulating module includes a weight block, a tilting sensing assembly and a driver. The tilting sensing assembly is adapted for sensing the tilting condition of the body and sending a left turning signal or a right turning signal. The driver is adapted to move the weight block according to the left turning signal or the right turning signal, so that the center of gravity of the carrier shifts to keep balance.

### CROSS-REFERENCE TO RELATED APPLICATION

This application claims the priority benefit of Taiwan application serial no. 102119977, filed on Jun. 5, 2013. The entirety of the above-mentioned patent application is hereby incorporated by reference herein and made a part of this specification.

1. Field of the Invention

The disclosure relates to a carrier, and more particularly, to a carrier capable to balance the centrifugal force thereof when the carrier makes a turn.

2. Description of Related Art

Carriers are used for carrying products, and generally move along a fixed path. In order to scheme out a comparatively larger numbers of paths under a certain area, turning paths made for the carriers are designed with larger curvatures (i.e., a path that the radius of curvature is smaller and the curving degree is larger) due to the limitation of space. However, when the carrier passes through such curving path, rollover may happen due to the centrifugal force.

Recently, in order to reduce the rollover, in general, the speed of the carrier when it makes a turn is reduced. However, the transporting efficiency would be decreased and the production capacity would be further affected. Another method of reducing rollover when making a turn is to increase the width of the bottom of the carrier, and by lowering the center of gravity the stability of the carrier when making a turn is improved. However, the carrier with a widened bottom not only occupies a larger space, but also may cause the adjacent carriers to scratch and crash since the distribution of moving paths is crowded.

### SUMMARY OF THE INVENTION

A carrier which is hard to tip when making a turn is provided.

The carrier of the disclosure includes a body and a gravity modulating module disposed at the body. The gravity modulating module includes a weight block, a tilting sensing assembly and a driver. The tilting sensing assembly is adapted for sensing a tilting condition of the body and transmitting a left turning signal or a right turning signal. The driver is adapted for adjusting a position of the weight block according to the left turning signal or the right turning signal, so that the center of gravity of the carrier shifts and the centrifugal force is offset to keep balance.

In light of the above, when the carrier of the disclosure makes a turn, the tilting sensing assembly detects the tilting condition of the body via methods of physical contact, electrical sensing, light sensing, or the like, and a left turning signal or a right turning signal is transmitted. Then the driver adjusts the position of the weight block according to the left turning signal or the right turning signal, so that the center of gravity of the carrier shifts and the centrifugal force is offset. Therefore, the carrier of the disclosure can remain stable and there is no need to reduce speed or widen the bottom of the body. A higher transporting efficiency can be maintained and the carrier can be used in an environment with a more crowded moving paths.

To make the above features and advantages of the present invention more comprehensible, several embodiments accompanied with drawings are described in detail as follows.

### BRIEF DESCRIPTION OF THE DRAWINGS

The accompanying drawings constituting a part of this specification are incorporated herein to provide a further understanding of the disclosure. Here, the drawings illustrate embodiments of the disclosure and, together with the description, serve to explain the principles of the disclosure.

FIG. 1 is a schematic view of a carrier according to an exemplary embodiment of the disclosure.

FIG. 2A is a schematic view of the tilting sensing assembly of the carrier depicted in FIG. 1 when the carrier does not make a turn yet.

FIG. 2B is a schematic view of the tilting sensing assembly of the carrier depicted in FIG. 1 when the carrier makes a turn.

FIG. 3A is a schematic view of the carrier depicted in FIG. 1 showing the related position of the weight block and the body when the carrier does not make a turn.

FIG. 3B and FIG. 3C are schematic views of the carrier depicted in FIG. 1 showing the related position of the weight block and the body when the carrier makes a turn.

FIG. 4A is a schematic view of a tilting sensing assembly of a carrier according to another exemplary embodiment of the disclosure.

FIG. 4B is a schematic view of the tilting sensing assembly of the carrier depicted in FIG. 4A when the the carrier makes a turn.

### DESCRIPTION OF EMBODIMENTS

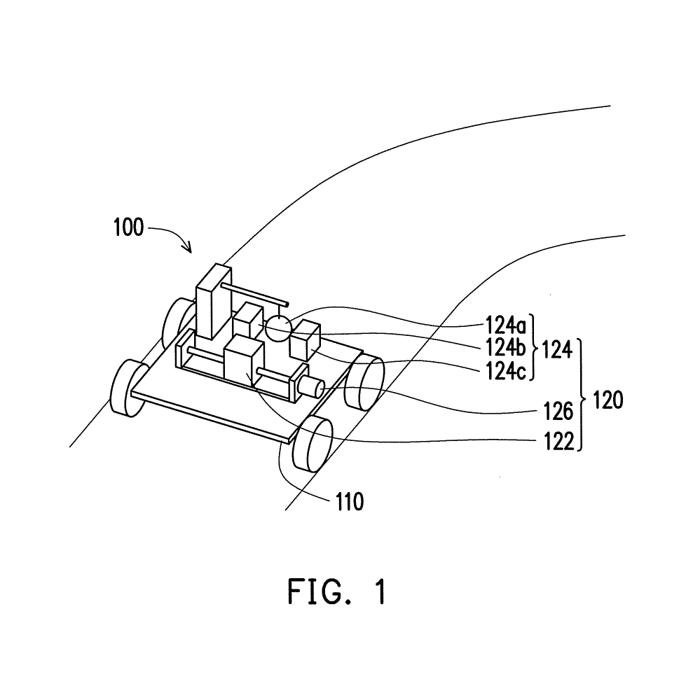

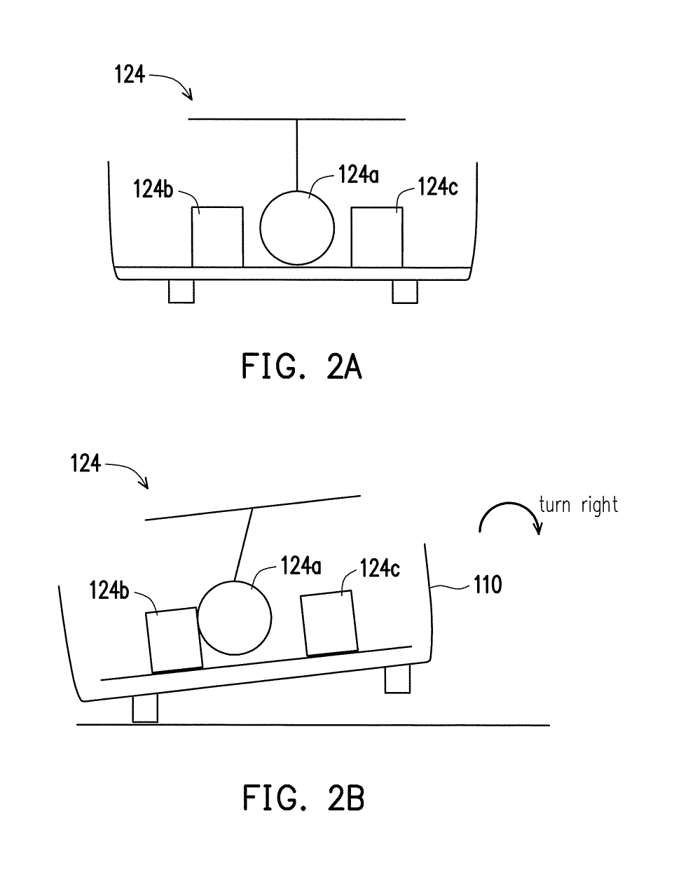

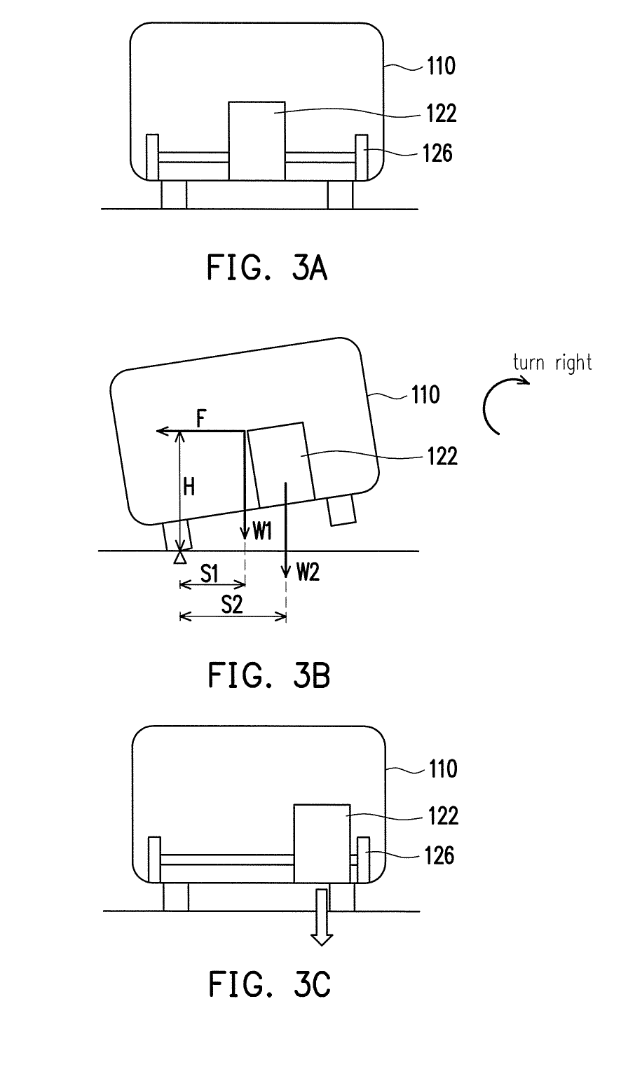

FIG. 1 is a schematic view of a carrier according to an exemplary embodiment of the disclosure. FIG. 2A is a schematic view of the tilting sensing assembly of the carrier depicted in FIG. 1 when the carrier does not make a turn yet. FIG. 3A is a schematic view of the carrier depicted in FIG. 1 showing the related position of the weight block and the body when the carrier does not make a turn.

Referring to FIG. 1, FIG. 2A and FIG. 3A, the carrier 100 of the embodiment includes a body 110 and a gravity modulating module 120 disposed at the body 110. The gravity modulating module 120 includes a weight block 122, a tilting sensing assembly 124 and a driver 126. The tilting sensing assembly 124 is adapted for sensing a tilting condition of the body 110 and transmitting a left turning signal or a right turning signal. In the embodiment, the tilting sensing assembly 124 includes a suspending member 124a and a left touch receiving member 124b and a right touch receiving member 124c disposed at the two sides of the suspending member 124a.

FIG. 2B is a schematic view of the tilting sensing assembly of the carrier depicted in FIG. 1 when the carrier makes a turn. FIG. 3B and FIG. 3C are schematic views of the carrier depicted in FIG. 1 showing the related position of the weight block and the body when the carrier makes a turn. When the body 110 makes a turn to the right as shown in FIG. 2B, the suspending member 124a swings to the left due to inertia to form an included angle in the gravity direction, and the swung suspending member 124a contacts with the left touch receiving member 124b. At this moment, the left touch receiving member 124b transmits a right turning signal. When the driver 126 receives the right turning signal, the driver 126 adjusts the position of the weight block 122, so that the center of gravity of the carrier 100 shifts to the right and keeps balance.

Similarly, when the body 110 turns left, the suspending member 124a swings to the right due to inertia, and the swung suspending member 124a contacts with the right touch receiving member 124c. At this moment, the right touch receiving member 124c transmits a left turning signal. When the driver 126 receives the left turning signal, the driver 126 adjusts the position of the weight block 122, so that the center of gravity of the carrier 100 shifts to the left and keeps balance. Certainly, the types and the detecting methods of the tilting sensing assembly 124 are not limited thereto.

After the driver 126 receives the left turning signal or the right turning signal, the weight block 122 is driven to move to the turning direction. In other words, after the driver 126 receives the left turning signal, the weight block 122 is driven to move to the left, and after the driver 126 receives the right turning signal, the weight block 122 is driven to move to the right. In the embodiment, the driver 126 includes a motor and a lead screw. However, in other embodiments, the driver 126 may also include an air cylinder or a hydraulic cylinder, and it is not limited thereto. The distance that the weight block 122 is required to move is described in detailed below.

Referring to FIG. 3B, it is given that the weight of the body 110 is W1, the weight of the weight block 122 is W2, the radius of curvature of the carrier 100 when making a turn is R (not shown), and the moving speed is V. The centrifugal force of the body 110 and the weight body 122 is F when the carrier 100 makes a turn.

F=(W1+W2)×V²/R

As shown in FIG. 3B, when the carrier 100 turns right, the right wheel thereof is slightly raised and the contact point of the left wheel and the ground is used as a pivot. In general, the position of the weight W1 of body 110 can be deemed as the mass-center position concentrated on the body 110 in the X direction, and the shortest or perpendicular distance from the weight W1 of the body 110 to the pivot is S1. When the carrier 100 does not make a turn, the weight block 122 is placed at the mass-center position of the body 110 in the X direction, thus the perpendicular distance from the weight of the weight block 122 before it is shifted to the pivot is S1, and the perpendicular distance from the weight of the shifted weight block 122 to the pivot is S2. The position of the centrifugal force F can be deemed as the mass-center position concentrated on the body 110 and the weight block 122 in the Y direction, and the perpendicular distance from the centrifugal force F to the pivot is H.

Since when the carrier 100 makes a turn, the weight block 122 is shifted in the X direction such that the carrier 100 may not topple, wherein the total moment of the carrier 100 (including the gravity moment of the body 110, the gravity moment of the weight block 122, the moment of the centrifugal force F of the body 110 and the weight block 122) is zero. It also means that: F×H+W1×S1+W2×S2=0

The centrifugal force F, the perpendicular distance from the centrifugal force F to the pivot H (i.e., the mass-center position of the body 110 and the weight block 122 in the Y direction), the weight of the body 110 W1, the perpendicular distance from the weight of the body 110 to the pivot S1, and the weight of the weight block 122 W2 are given. Therefore, from the abovementioned equation, the perpendicular distance from the weight of the shifted weight block 122 to the pivot S2 can be obtained. Then, the distance that the weight block 122 requires to shift can be obtained by subtracting the perpendicular distance from the weight of the weight block 122 before it is shifted to the pivot S1 from the perpendicular distance from the weight of the shifted weight block 122 to the pivot S2.

It should be mentioned that, in the embodiment, since the weight of the tilting sensing assembly 124 and the driver 126 is much less than that of the body 110 and the weight block 122. For simplicity's sake, the weight of the tilting sensing assembly 124 and the driver 126 is omitted herein. However, in other embodiments, the designer can modify the abovementioned equation according to actual requirements as long as the total moment of the carrier 100 is zero.

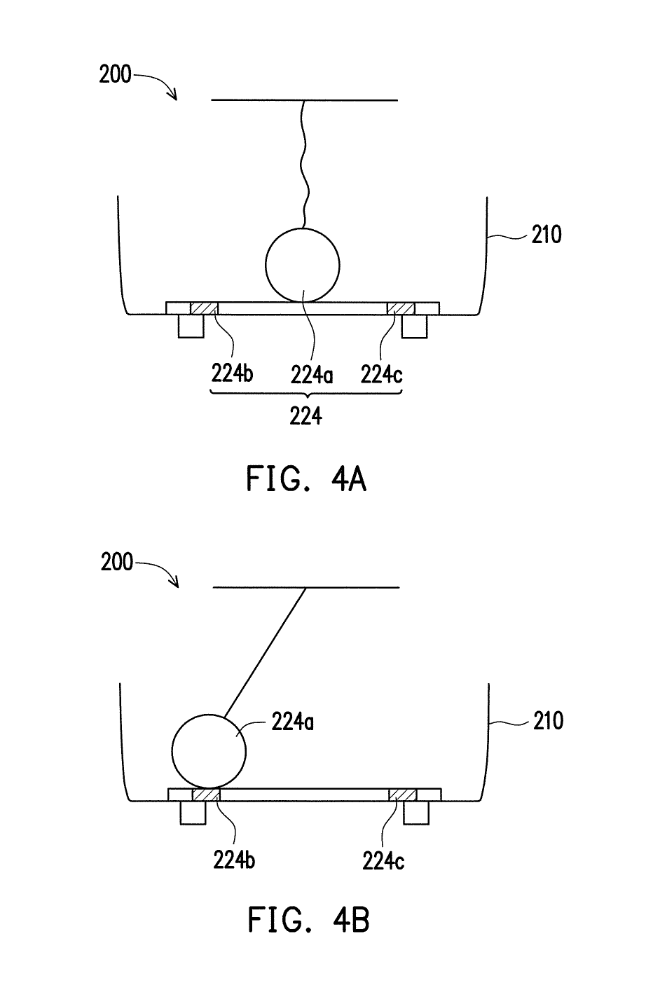

FIG. 4A is a schematic view of a tilting sensing assembly of a carrier according to another exemplary embodiment of the disclosure. FIG. 4B is a schematic view of the tilting sensing assembly of the carrier depicted in FIG. 4A when the the carrier makes a turn. Referring to FIG. 4A and FIG. 4B, one major structural difference between the carrier 200 of the present embodiment and the one in FIG. 1 is that the tilting sensing assemblies 124, 224 are not the same. In FIG. 1, through the compression force between the suspending member 124a and the left and right receiving members 124b, 124c, the tilting sensing assembly 124 detects if it is contacted or not, however in the present embodiment electricity conductance is used for detecting. Detailed explanations are given below.

The tilting sensing assembly 224 of the embodiment includes a conductive ball 224a, a left electric signal receiving member 224b and a right electric signal receiving member 224c. As shown in FIG. 4A, when the body 210 does not make a turn, the conductive ball 224a is located on a plane which has the same height as the left electric signal receiving member 224b and the right electric signal receiving member 224c. At this time, the conductive ball 224a is fixed on the top surface of the body 210 with a slacken rope, and the conductive ball 224a is located between the left electric signal receiving member 224b and the right electric signal receiving member 224c.

As shown in FIG. 4B, when the body 210 turns right, the conductive ball 224a may slide to the left and conducts electricity to the left electric signal receiving member 224b. At this time, the rope between the conductive ball 224a and the top surface of the body 210 is in a tight condition, so as to prevent the conductive ball 224a further slides to the left. At this time, the left electric signal receiving member 224b transmits a right turning signal. Similarly, when the body 210 turns left, the conductive ball 224a may slide to the right and conducts electricity to the right electric signal receiving member 224c, and the right electric signal receiving member 224c transmits a left turning signal.

Certainly, the types of the titling sensing assembly 224 are not limited as abovementioned. In other embodiments, the tilting sensing assembly can use optical signal sensing method to determine the tilting condition of the body. For instance, the titling sensing assembly including a shielding member, a left light receiving member and a right light receiving member. When the body makes a turn, the shielding member shifts to be located above the left light receiving member or the right light receiving member so as to block a light signal, and so that the left light receiving member or the right light receiving member transmits a right turning signal or a left turning signal.

Certainly, a plurality of left light receiving members and a plurality of right light receiving members can be disposed on the tilting sensing assembly, and the left light receiving members and the right light receiving members can be arranged in the X direction. Since the amplitude of swing of the shielding member varies with the amplitude of turning of the carrier, the shielding member blocks the light signal of the left light receiving member or the right receiving member located at different positions, such that the tilting condition of the body is determined. Accordingly, the position of the weight block can be adjusted and the carrier can be kept stable even when the carrier is in a very slight tilting condition.

Or, the titling sensing assembly may include a light emitting device, a left light receiving member and a right light receiving member. When the body makes a turn, the light emitting device shifts to be located above the left light receiving member or the right light receiving member, so that the left light receiving member or the right light receiving member detects a light signal and transmits a right turning signal or a left turning signal. Only some types of tilting sensing assembly and sensing methods thereof are provided as mentioned above, however the tilting sensing assembly is not limited thereto.

In light of the foregoing, when the carrier of the disclosure makes a turn, the tilting sensing assembly detects the tilting condition of the body via methods of physical contact, electrical sensing, light sensing, or the like, and a left turning signal or a right turning signal is transmitted. Then the driver adjusts the position of the weight block according to the left turning signal or the right turning signal, so that the center of gravity of the carrier shifts to keep balance. Therefore, the carrier of the disclosure can remain stable and there is no need to reduce speed or widen the bottom of the body. A higher transporting efficiency can be maintained and the carrier can be used in an environment with a more crowded moving paths.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A carrier, comprising:
a body; and
a gravity modulating module disposed at the body, the gravity modulating module comprising:
a weight block;
a tilting sensing assembly adapted for sensing a tilting condition of the body and sending a left turning signal or a right turning signal; and
a driver adapted for adjusting a position of the weight block according to the left turning signal or the right turning signal, so that a center of gravity of the carrier shifts to keep balance.

2. The carrier as claimed in claim 1, wherein the tilting sensing assembly comprises a suspending member and a left touch receiving member and a right touch receiving member disposed at two sides of the suspending member, when the body makes a turn, the suspending member swings and contacts with the left touch receiving member or the right touch receiving member.

3. The carrier as claimed in claim 1, wherein the tilting sensing assembly comprises a conductive ball, a left electric signal receiving member and a right electric signal receiving member, when the body makes a turn, the conductive ball shifts and is adapted to conduct electricity to the left electric signal receiving member or the right electric signal receiving member.

4. The carrier as claimed in claim 1, wherein the tilting sensing assembly comprises a shielding member, a left light receiving member and a right light receiving member, when the body makes a turn, the shielding member shifts to be located above the left light receiving member or the right light receiving member so as to block a light signal.

5. The carrier as claimed in claim 1, wherein the tilting sensing assembly comprises a light emitting device, a left light receiving member and a right light receiving member, when the body makes a turn, the light emitting device shifts to be located above the left light receiving member or the right light receiving member, so that the left light receiving member or the right light receiving member detects a light signal.

6. The carrier as claimed in claim 1, wherein after the left turning signal or the right turning signal is transmitted, the weight block moves in a turning direction.

7. The carrier as claimed in claim 1, wherein when the carrier makes a turn, a total moment of the carrier is zero.

8. The carrier as claimed in claim 7, wherein the total moment of the carrier comprises a gravitational moment of the body, a centrifugal moment of the body, a gravitational moment of the weight block and a centrifugal moment of the weight block.

9. The carrier as claimed in claim 1, wherein the driver comprises a motor, a lead screw, an air cylinder or a hydraulic cylinder.
